(19) United States
(12) Patent Application Publication
(10) Pub. No.: US 2024/0362144 A1
(43) Pub. Date: Oct. 31, 2024

(54) SYSTEM AND METHOD FOR MONITORING DATA PROCESSING SYSTEM PERFORMANCE USING A DIGITAL TWIN

(71) Applicant: Dell Products L.P., Round Rock, TX (US)

(72) Inventors: OFIR EZRIELEV, Be'er Sheva (IL); TOMER KUSHNIR, Omer (IL); MAXIM BALIN, Gan-Yavne (IL)

(21) Appl. No.: 18/309,185

(22) Filed: Apr. 28, 2023

(51) Int. Cl. G06F 11/34; G06F 11/30

(52) U.S. Cl. CPC G06F 11/3457; G06F 11/3006; G06F 11/3058

(57) ABSTRACT

Methods and systems for managing performance of data processing systems throughout a distributed environment are disclosed. To manage performance of data processing systems, a system may include a data processing system manager and one or more data processing systems. If operation of a data processing system of the one or more data processing systems meets certain criteria, the data processing system manager may operate a digital twin of the data processing system. Simulated operational data obtained from the digital twin may be compared to operational data from the data processing system. If the simulated operational data and the operational data match within a threshold, the data processing system meeting the criteria may be due to environmental conditions. If the simulated operational data does not match the operational data within the threshold, the data processing system may be deteriorating and may require further intervention.

### FIELD

Embodiments disclosed herein relate generally to monitoring performance of data processing systems throughout a distributed environment. More particularly, embodiments disclosed herein relate to systems and methods for deducing potential reasons for deterioration of performance by data processing systems over time.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIG. 2A shows a block diagram illustrating a data processing system manager monitoring operations performed by data processing systems in accordance with an embodiment.

FIG. 2B shows a block diagram illustrating a data processing system manager determining whether operation of data processing systems meets criteria in accordance with an embodiment.

FIG. 2C shows a block diagram illustrating a data processing system manager deducing whether an environmental factor has caused operation of a first data processing system to meet the criteria in accordance with an embodiment.

FIG. 2D shows a block diagram illustrating a data processing system manager deducing whether an environmental factor has caused operation of a second data processing system to meet the criteria in accordance with an embodiment.

FIG. 3 shows a flow diagram illustrating a method of monitoring data processing system performance in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

In general, embodiments disclosed herein relate to methods and systems for monitoring operation of data processing systems throughout a distributed environment. To monitor the operation, the system may include a data processing system manager. The data processing system manager may, for example, collect operational data indicative of the performance of a data processing system. If the operational data meets certain criteria (e.g., deviates from an expectation, meets a threshold, etc.) the data processing system manager may perform actions to remediate a perceived deficit in the operation of the data processing system.

However, changes to the operation of the data processing system may occur in response to transient environmental conditions (e.g., adverse weather conditions, etc.) and/or other external factors and the data processing system may not be deteriorating or otherwise losing functionality. Therefore, the system may dedicate resources to investigating and attempting to remediate situations suggesting less than nominal operation of the data processing system, which may cause unnecessary resource expenditure and/or delays in performance of computer-implemented services facilitated by the data processing system.

To conserve resources and/or avoid delays throughout the distributed environment while investigating the cause of a less than nominal performance by the data processing system, the data processing system manager may host and operate a digital twin of the data processing system. Environmental data representative of the environment in which the data processing system was positioned when the non-nominal operation occurred may be collected and used to facilitate operation the digital twin. Simulated operational data may be obtained based on the operation of the digital twin (and taking into account the environmental data).

The operational data may be compared to the simulated operational data. If the operational data and the simulated operational data match within a threshold, the environmental conditions may be inferred to be the cause of the non-nominal operation of the data processing system. If the operational data and the simulated operational data do not match within the threshold, the environmental conditions may not be inferred to be the cause of the non-nominal operation of the data processing system. In this instance, deterioration of the data processing system may be inferred to be the cause and further actions may be taken to remediate the perceived deficit in performance.

Thus, interruptions to data processing system performance likely to be caused by environmental factors may be identified. By doing so, resources and time may be conserved for scenarios where deterioration of the data processing system has a higher likelihood of occurring.

In an embodiment, a method of managing functionality of data processing systems throughout a distributed environment by a data processing system manager is provided. The method may include: identifying an occurrence of a first event indicating that first operation of a first data processing system of the data processing systems meets criteria for a first duration of time; making a first determination, based on the occurrence of the first event, regarding whether the first operation matches first simulated operation of the first data processing system within a threshold, the first simulated operation being obtained using a digital twin of the first data processing system and being intended to duplicate operation of the first data processing system under first environmental conditions representative of a first environment in which the first data processing system was positioned during the first duration of time; in an instance of the first determination in which the first operation matches the first simulated operation within the threshold: continuing to operate the first data processing system without attempting to remediate an apparent performance deficit in the first operation indicated by the criteria.

Identifying the occurrence of the first event may include: obtaining operational data for the first data processing system during the first duration of time, the operational data representing the first operation; and comparing the operational data to the criteria.

Making the first determination may include: obtaining simulated operational data for the first data processing system, the simulated operational data being based on: simulated nominal operation of the first data processing system using the digital twin, and the first environmental conditions; obtaining a difference based on the operational data and the simulated operational data; and comparing the difference to the threshold.

Obtaining the simulated operational data may include: obtaining environmental data indicating the first environmental conditions; and initiating operation of the digital twin based on the first environmental conditions.

Obtaining the environmental data may include: querying a meteorological data source to request weather data for the first environment.

Obtaining the environmental data may also include: generating, based on the environmental data and historical environmental data for environments proximal to the first environment, synthetic environmental data indicating likely environmental conditions of the proximal environments during the first duration of time; and adding the synthetic environmental data to the environmental data.

Continuing to operate the first data processing system may include: deducing that the first environmental conditions are responsible for the first operation meeting the criteria.

The method may also include: identifying an occurrence of a second event indicating that second operation of a second data processing system of the data processing systems meets the criteria for a second duration of time; making a second determination, based on the occurrence of the second event, regarding whether the second operation matches second simulated operation of the second data processing system within the threshold, the second simulated operation being obtained using a digital twin of the second data processing system and being intended to duplicate operation of the second data processing system under second environmental conditions representative of a second environment in which the second data processing system was positioned during the second duration of time; in an instance of the second determination in which the second operation does not match the second simulated operation within the threshold: performing an action set to attempt to remediate a performance deficit in the second operation.

Performing the action set may include: deducing that the second environmental conditions are not responsible for the second operation meeting the criteria and that deterioration of the second data processing system is responsible for the second operation meeting the criteria.

The second operation may be substantially similar to the first operation and the first environmental conditions may be different from the second environmental conditions.

The first event may be a first reduction in computation speed by the first data processing system and the second event may be a second reduction in computation speed by the second data processing system, the first reduction being substantially similar to the second reduction.

The first operational data may include at least one characteristic selected from a list of characteristics consisting of: a rate of computations performed by the first data processing system; a range of data transmissions by the first data processing system; and a quantification of accuracy of operations performed by the first data processing system.

The threshold may be a multi-dimensional threshold including a list of thresholds, each threshold of the list of the thresholds corresponding to a characteristic of the list of the characteristics.

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer instructions are executed by the processor.

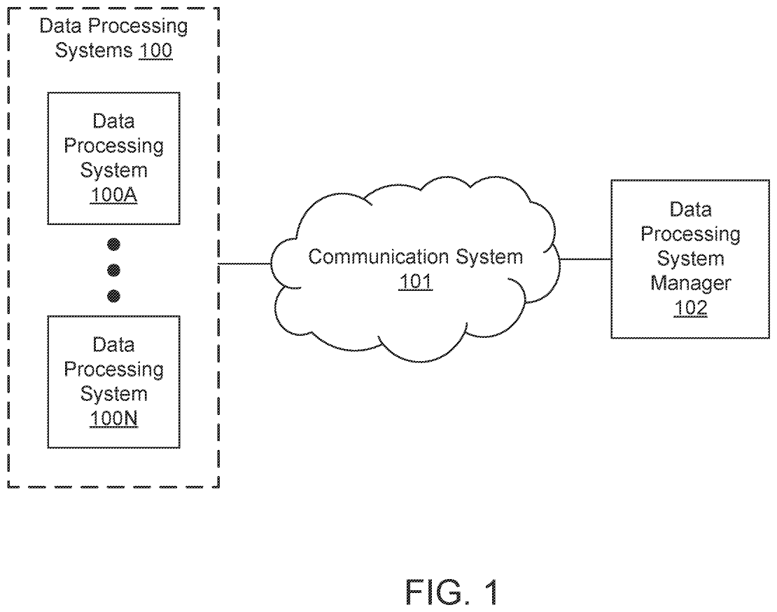

Turning to FIG. 1, a block diagram illustrating a system in accordance with an embodiment is shown. The system shown in FIG. 1 may provide computer-implemented services. The computer-implemented services may include any type and quantity of computer-implemented services. For example, the computer-implemented services may include monitoring services (e.g., of locations), communication services, and/or any other type of computer-implemented services.

To provide the computer-implemented services, the system may include data processing system manager 102. Data processing system manager 102 may provide all, or a portion of, the computer-implemented services. For example, data processing system manager 102 may provide computer-implemented services to users of data processing system manager 102 and/or other computing devices operably connected to data processing system manager 102.

To facilitate performance of the computer-implemented services, the system may include one or more data processing systems 100. Data processing systems 100 may include any number of data processing systems (e.g., 100A-100N). For example, data processing systems 100 may include one data processing system (e.g., 100A) or multiple data processing systems (e.g., 100A-100N) that may independently and/or cooperatively facilitate the computer-implemented services.

All, or a portion, of data processing systems 100 may provide (and/or participate in and/or support the) computer-implemented services to various computing devices operably connected to data processing systems 100. Different data processing systems may provide similar and/or different computer-implemented services.

When providing the computer-implemented services, the system of FIG. 1 may monitor performance of data processing systems throughout a distributed environment. Data indicating a change in the performance of a data processing system of the data processing systems (e.g., a change in the rate of computation performance, etc.) may trigger the data processing system manager to attempt to intervene with the performance change.

However, changes in performance of the data processing system may be due to transient conditions (e.g., weather and/or other external factors) that do not stem from deterioration of the data processing system. Therefore, dedicating time and resources to further analysis of a data processing system subject to transient environmental conditions may lead to unnecessary performance delays and/or other interruptions to computer-implemented services facilitated by the data processing system.

In general, embodiments disclosed herein may provide methods, systems, and/or devices for deducing whether changes to performance of data processing systems are due to environmental factors. To do so, the system of FIG. 1, may determine whether operation of the data processing system meets criteria. If the operation of the data processing system meets the criteria, the system of FIG. 1 may attempt to determine whether the operation meeting the criteria is due to environmental conditions.

To do so, the system of FIG. 1 may host and operate a digital twin of the data processing system. The digital twin may be intended to duplicate operation of the data processing system under environmental conditions representative of an environment in which the data processing system was positioned when the criteria was met.

Operational data (e.g., indicating characteristics such as a rate of computation performance, etc.) may be obtained from the data processing system. Simulated operational data may be obtained using the digital twin and environmental data indicating the environmental conditions.

If the operational data matches (within a threshold) the simulated operational data, it may be inferred that the environmental conditions contributed to the criteria being met. If the operational data does not match the simulated operational data within the threshold, it may be inferred that the environmental conditions are not the only reason for the operation meeting the criteria and the data processing system may be deteriorating. By identifying data processing systems that may be affected by transient environmental conditions, resources may be conserved by the system by not performing additional actions to investigate the operability of these data processing systems.

To provide the above noted functionality, the system of FIG. 1 may include data processing system manager 102. Data processing system manager 102 may: (i) identify an occurrence of an event indicating that operation of a data processing system meets criteria for a duration of time and/or (ii) determine whether the operation matches simulated operation of the data processing system within a threshold. If the operation matches the simulated operation within the threshold, data processing system manager 102 may continue to operate the data processing system without attempting to remediate an apparent performance deficit in the operation indicated by the criteria. If the operation does not match the simulated operation within the threshold, data processing system manager 102 may perform an action set to attempt to remediate the performance deficit in the operation.

The simulated operation of the data processing system may be generated using a digital twin of the data processing system. The digital twin may perform computations identical to computations performed by the data processing system while accounting for environmental conditions. Therefore, the simulated operation of the data processing system may be based on: (i) simulated nominal operation of the data processing system using the digital twin and (ii) the environmental conditions.

The operation may be compared to the simulated operation using a multi-dimensional threshold including metrics such as: (i) rate of computation execution, (ii) rate of data transmission, etc.

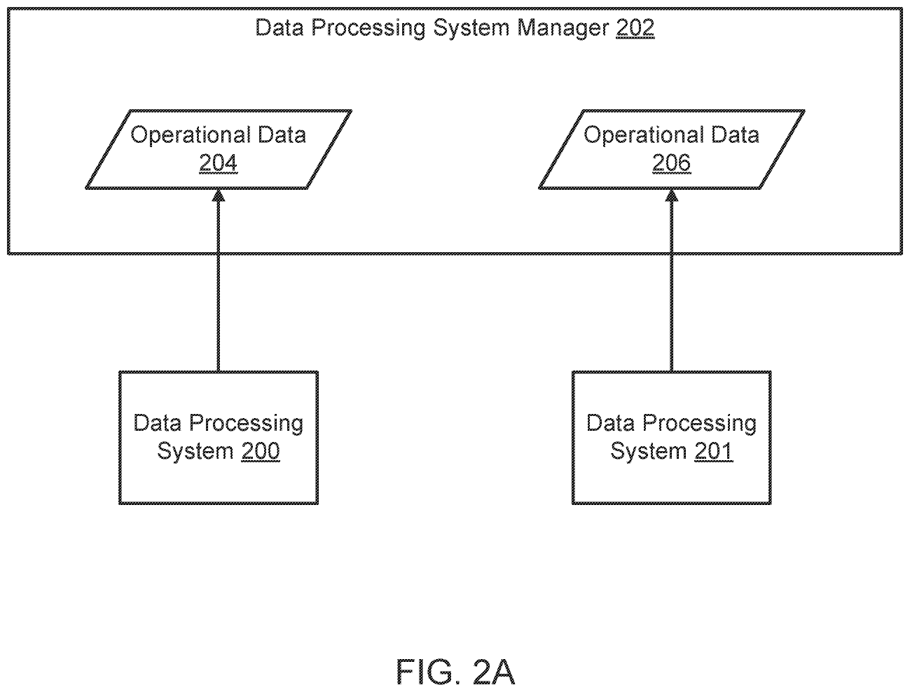

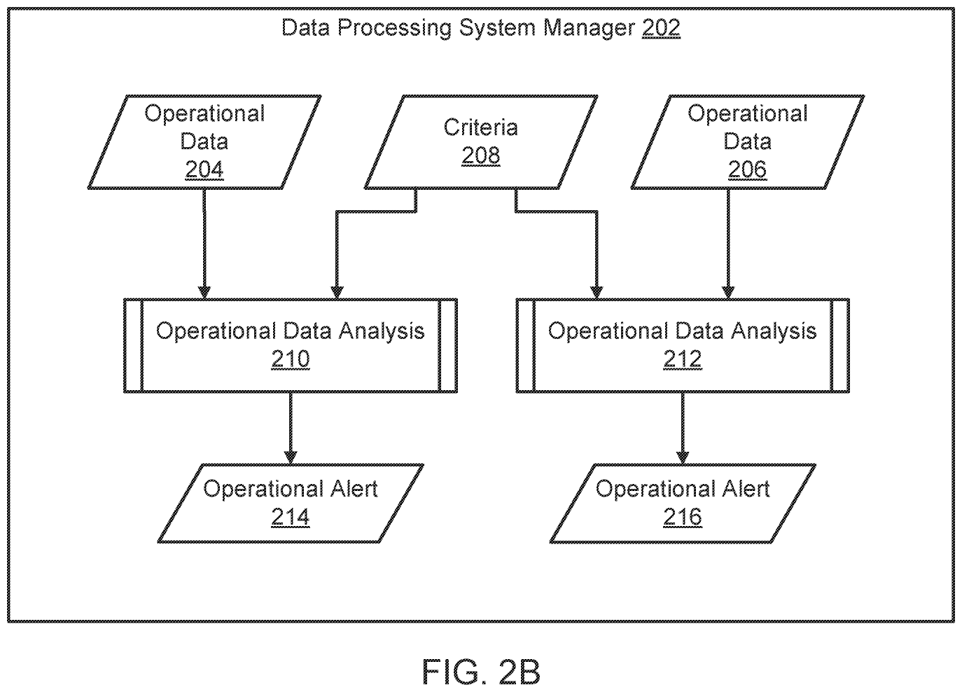

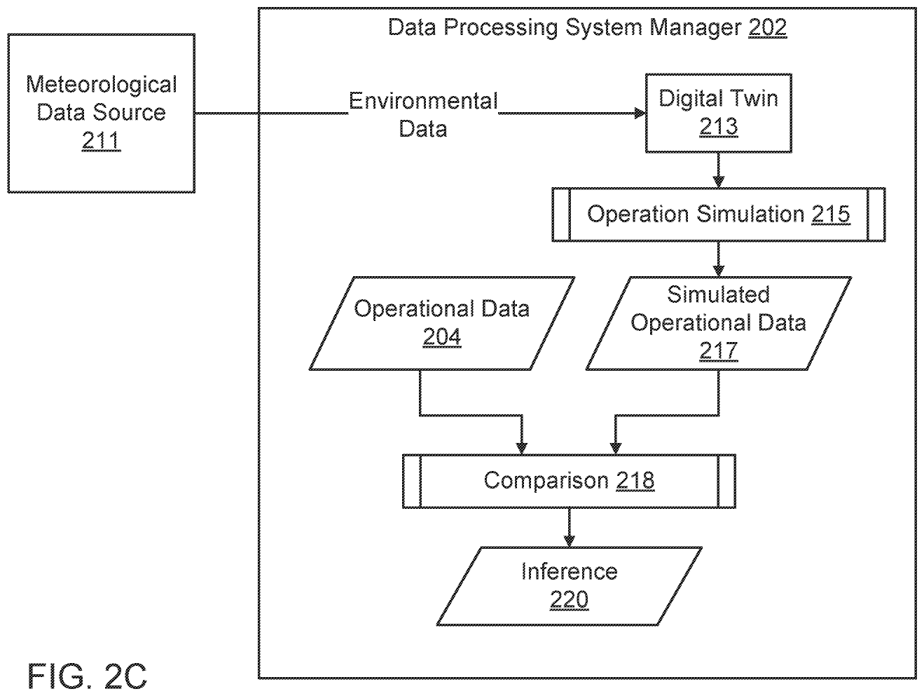

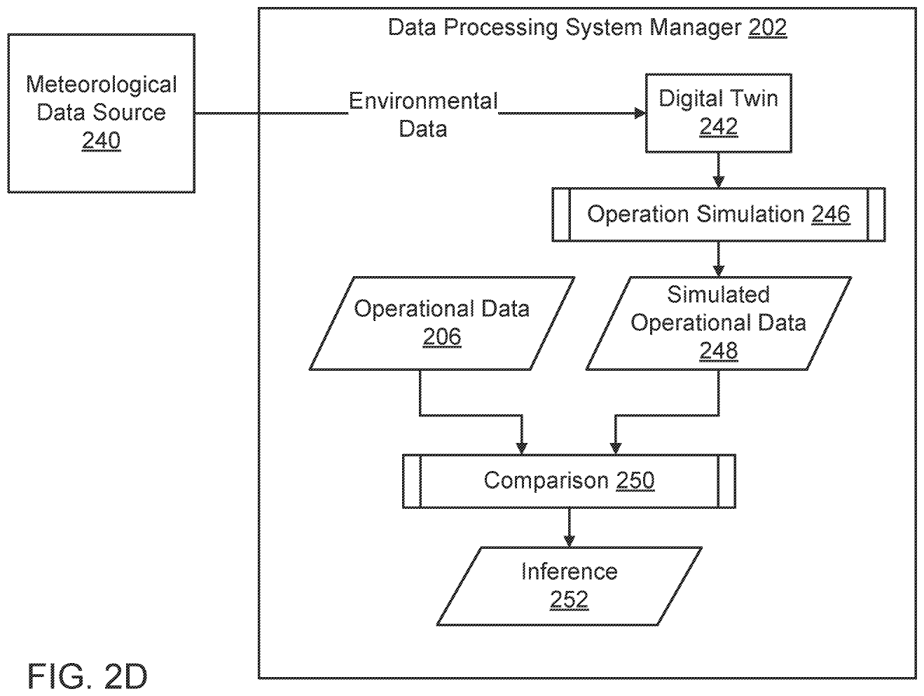

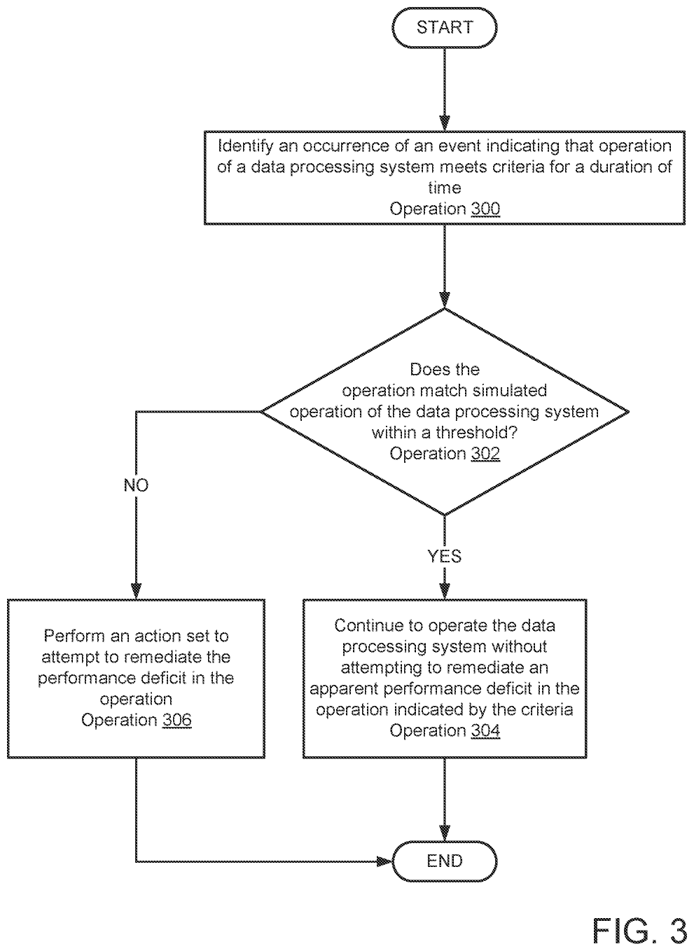

When performing its functionality, data processing system manager 102 and/or data processing systems 100 may perform all, or a portion, of the methods and/or actions shown in FIGS. 2A-3.

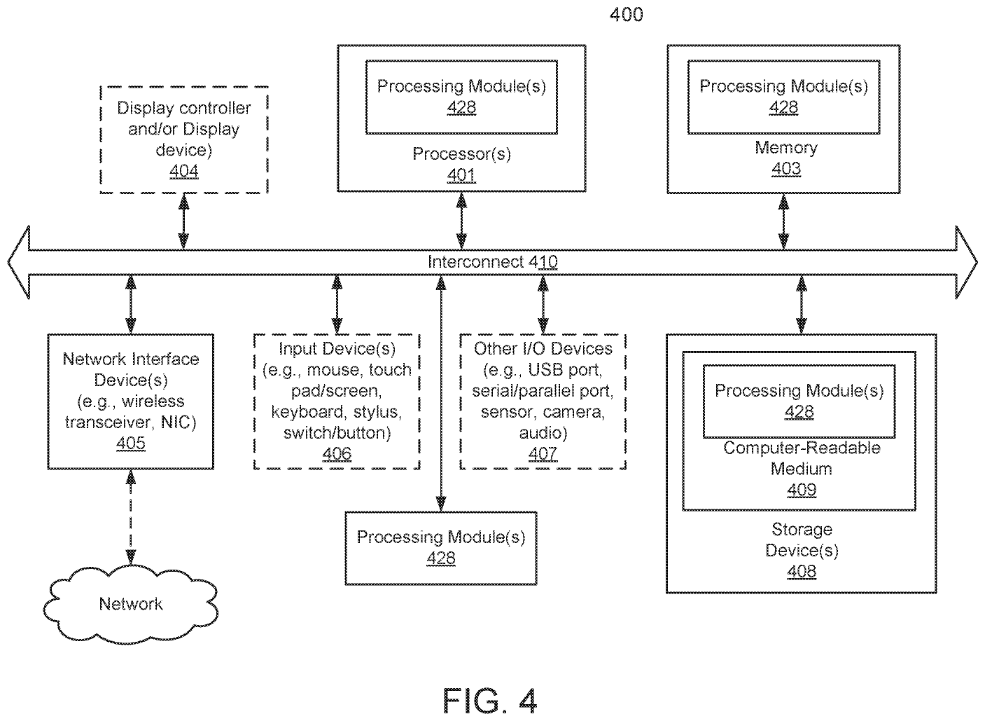

Data processing systems 100 and/or data processing system manager 102 may be implemented using a computing device such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

In an embodiment, one or more of data processing systems 100 and/or data processing system manager 102 are implemented using an internet of things (IoT) device, which may include a computing device. The IoT device may operate in accordance with a communication model and/or management model known to data processing system manager 102, other data processing systems, and/or other devices.

Any of the components illustrated in FIG. 1 may be operably connected to each other (and/or components not illustrated) with a communication system 101. In an embodiment, communication system 101 may include one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

To further clarify embodiments disclosed herein, a diagram illustrating data flows and/or processes performed in a system in accordance with an embodiment are shown in FIGS. 2A-2D.

FIG. 2A shows a block diagram of a data processing system manager monitoring operations performed by data processing systems in accordance with an embodiment. Data processing system manager 202 may be similar to data processing system manager 102 shown in FIG. 1. Data processing system 200 and data processing system 201 may be similar to any of data processing systems 100 shown in FIG. 1. Data processing system manager 202 may be connected to data processing system 200 and data processing system 201 via a communication system (not shown). Communications between data processing system manager 202, data processing system 200, and data processing system 201 are illustrated using lines terminating in arrows.

Data processing system 200 and data processing system 201 may include data collectors and/or may be associated with sensors positioned to collect measurements (e.g., temperature measurements, humidity measurements, etc.) representative of an ambient environment in which the sensors are positioned. Data processing system 200 may be positioned in a first environment and data processing system 201 may be positioned in a second environment. Therefore, data processing system 200 may be subject to first environmental conditions and data processing system 201 may be subject to second environmental conditions, the first environmental conditions being different from the second environmental conditions.

Data processing system manager 202 may obtain operational data 204 from data processing system 200 and operational data 206 from data processing system 201. Operational data 204 and operational data 206 may be obtained at regular intervals (e.g., hourly, daily, etc.), upon request by data processing system manager 202, and/or according to any other schedule. Operational data 204 may include: (i) a rate of computations performed by data processing system 200, (ii) a range of data transmissions by data processing system 200, (iii) a quantification of accuracy of operations performed by data processing system 200, and/or other statistics related to the performance of data processing system 200. Operational data 204 may also include: (i) temperatures of components of data processing system 200, (ii) power draw of components of data processing system 200, (iii) operation of cooling devices of data processing system 20, and/or (iv) other data.

Similarly, operational data 206 may include: (i) a rate of computations performed by data processing system 201, (ii) a range of data transmissions by data processing system 201, (iii) a quantification of accuracy of operations performed by data processing system 201, and/or other statistics related to the performance of data processing system 201.

Turning to FIG. 2B, data processing system manager 202 may identify an occurrence of a first event indicating that first operation of data processing system 200 meets criteria 208 and an occurrence of a second event indicating that second operation of data processing system 201 meets criteria 208. The first operation may be substantially similar to the second operation.

The occurrence of the first event may include obtaining operational data 204 from data processing system 200 and/or other actions. Similarly, the occurrence of the second event may include obtaining operational data 206 from data processing system 201 and/or other actions.

For example, the first event may be a first reduction in computation speed by data processing system 200 and the second event may be a second reduction in computation speed by data processing system 201. The first reduction may be substantially similar to the second reduction and data processing system manager 202 may not be able to distinguish between the cause of the first event and the cause of the second event.

The first environment (e.g., where data processing system 200 is located) may have experienced adverse weather conditions (e.g., a rain storm) during the duration of time when operational data 204 was obtained. Data processing system 201 may not have experienced any adverse weather conditions during the duration of time.

As previously mentioned, data processing system manager 202 may determine whether operational data 204 and operational data 206 meet criteria 208. Criteria 208 may be hosted in storage by data processing system manager 202 and may be based on any standards used to evaluate the performance of data processing systems throughout the distributed environment (e.g., data processing system 200, data processing system 201, etc.).

Criteria 208 may include any number of thresholds corresponding to components of operational data 204 and operational data 206. Thresholds corresponding to the components of operational data 204 may or may not be different from thresholds corresponding to the components of operational data 206. For example, criteria 208 may be met if a rate of data transmissions by data processing system 200 and/or data processing system 201 falls below a threshold.

Data processing system manager 202 may perform operational data analysis 210 process to determine whether operational data 204 meets criteria 208. Operational data analysis 210 process may include, for example, comparing a rate of data transmission included in operational data 204 to the data transmission rate threshold included in criteria 208.

Data processing system manager 202 may determine, via operational data analysis 210 process, that operational data 204 meets criteria 208 and may generate operational alert 214 indicating a requirement for further analysis of data processing system 200. In addition, data processing system manager 202 may determine, via operational data analysis 212, that operational data 206 meets criteria 208 and may generate operational alert 216 indicating a requirement for further analysis of data processing system 201.

Operational data 204 and operational data 206 may present similar data representing operation of data processing system 200 and data processing system 201 respectively. For example, operational data 204 and operational data 206 may each present a slower than expected (e.g., based on criteria 208) rate of data transmissions during the duration of time. Therefore, it may be difficult for data processing system manager 202 to determine the cause of the slower than expected rates of data transmissions and to determine whether the rain storm is the cause of the slower than expected rate of data transmissions from data processing system 200.

Turning to FIG. 2C, data processing system manager 202 may attempt to deduce whether operational data 204 meeting criteria 208 is due to an environmental condition (e.g., the rain storm) or whether data processing system 200 is deteriorating and requires further intervention.

To do so, data processing system manager 202 may obtain environmental data from meteorological data source 211. The environmental data may include data corresponding to weather conditions of the environment in which data processing system 200 was positioned during the duration of time over which operational data 204 was obtained. For example, the environmental data may include a report describing a heavy rain storm in the first environment during the duration of time over which operational data 204 was obtained.

The environmental data may also include synthetic environmental data generated using the environmental data and historical environmental data for environments proximal to the first environment. The synthetic environmental data may indicate likely environmental conditions of the proximal environments during the duration of time over which operational data 204 was obtained.

The environmental data (including the synthetic environmental data) may be used by digital twin 213 to simulate operation of data processing system 200 under a range of potential environmental conditions. By doing so, environmental conditions that may have a larger effect on the operation of data processing system 200 may not be evaluated in isolation.

Digital twin 213 may include a data structure with instructions to simulate operation of data processing system 200. Data processing system manager 202 may be able to simulate operation of data processing system 200 under a range of possible environmental conditions present during the duration of time during which operational data 204 was obtained using the environmental data and digital twin 213. Simulated operation of data processing system 200 using digital twin 213 may be intended to duplicate operation of data processing system 200 under first environmental conditions representative of the first environment in which data processing system 200 was positioned during the duration of time.

Data processing system manager 202 may perform operational simulation 215 process using digital twin 213 to simulate operation of data processing system 200 under various environmental conditions. Operation simulation 215 process may utilize input data (not shown) obtained from data processing system 200, the environmental data, and/or other data to generate simulated operational data 217.

In addition, the environmental conditions may be expanded to include various scenarios of attack on the system by a malicious entity. To do so, operational simulation 215 process may include simulating: (i) operation of data processing system 200 under a variety of environmental conditions assuming no adversarial attack, and/or (ii) operation of data processing system 200 under a variety of environmental conditions and experiencing a variety of adversarial attacks. Any number of simulations may be run to include different iterations of the above-mentioned scenarios.

Simulated operational data 217 may be based on: (i) simulated nominal operation of data processing system 200 using digital twin 213, (ii) the first environmental conditions, and/or (iii) various simulated adversarial attack scenarios. Simulated operational data 217 may include characteristics of the simulated operation corresponding to the characteristics included in operational data 204. For example, simulated operational data 217 may include a percent accuracy of computations performed, a rate of data transmission, a rate of computations performed, and/or other characteristics (e.g., including physical and/or mechanical characteristics such as temperatures of components, power draw of components, operability of cooling devices, etc.).

Data processing system manager 202 may perform comparison 218 process using operational data 204, simulated operational data 217, and a threshold (not shown) to obtain inference 220. The threshold may be a multi-dimensional threshold including a list of thresholds, each threshold from the list of the thresholds corresponding to a characteristic of the list of characteristics included in operational data 204.

Comparison 218 process may include obtaining a difference between components of operational data 204 and simulated operational data 217. For example, a rate of data transmission reported by operational data 204 may be subtracted from a rate of data transmission reported by simulated operational data 217. The difference between the rates of data transmission may be compared to a threshold (e.g., a maximum acceptable difference in rates of data transmission).

In FIG. 2C, the difference between operational data 204 and simulated operational data 217 may not exceed the threshold. Therefore, inference 220 may indicate that the perceived deficit in performance by data processing system 200 may be related to the environmental conditions.

Turning to FIG. 2D, data processing system manager 202 may attempt to deduce whether operational data 206 meeting criteria 208 is due to an environmental condition or whether data processing system 201 is deteriorating and requires intervention.

To do so, data processing system manager 202 may perform operations similar to those described with reference to data processing system 200 in FIG. 2C.

Data processing system manager 202 may obtain environmental data from meteorological data source 240. The environmental data may include data corresponding to weather conditions of the environment in which data processing system 201 was positioned during the duration of time over which operational data 206 was obtained (the environmental data in FIG. 2D being different from the environmental data in FIG. 2C).

The environmental data may also include synthetic environmental data generated using the environmental data and historical environmental data for environments proximal to the second environment. The synthetic environmental data may indicate likely environmental conditions of the proximal environments during the duration of time over which operational data 206 was obtained.

The environmental data (including the synthetic environmental data) may be used by digital twin 242 to simulate operation of data processing system 201 under a range of potential environmental conditions. By doing so, environmental conditions that may have a larger effect on the operation of data processing system 201 may not be evaluated in isolation.

Digital twin 242 may include a data structure with instructions to simulate operation of data processing system 201. Data processing system manager 202 may be able to simulate operation of data processing system 201 under a range of possible environmental conditions present during the duration of time during which operational data 206 was obtained using the environmental data and digital twin 242. Simulated operation of data processing system 201 using digital twin 242 may be intended to duplicate operation of data processing system 201 under second environmental conditions representative of the second environment in which data processing system 201 was positioned during the duration of time.

Data processing system manager 202 may perform operational simulation 246 process using digital twin 242 to simulate operation of data processing system 201. Operation simulation 246 process may utilize input data (not shown) obtained from data processing system 201, the environmental data, and/or other data to generate simulated operational data 248.

Simulated operational data 248 may be based on: (i) simulated nominal operation of data processing system 201 using digital twin 242, and/or (ii) the second environmental conditions. Simulated operational data 248 may include characteristics of the simulated operation corresponding to the characteristics included in operational data 206. For example, simulated operational data 248 may include a percent accuracy of computations performed, a rate of data transmission, a rate of computations performed, and/or other characteristics.

Data processing system manager 202 may perform comparison 250 process using operational data 206, simulated operational data 248, and a threshold (not shown) to obtain inference 252. The threshold may be a multi-dimensional threshold including a list of thresholds, each threshold from the list of the thresholds corresponding to a characteristic of the list of characteristics included in operational data 206.

Comparison 250 process may include obtaining a difference between components of operational data 206 and simulated operational data 248. For example, a rate of data transmission reported by operational data 206 may be subtracted from a rate of data transmission reported by simulated operational data 248. The difference between the rates of data transmission may be compared to a threshold (e.g., a maximum acceptable difference in rates of data transmission).

In FIG. 2D, the difference between operational data 206 and simulated operational data 248 may exceed the threshold. Therefore, inference 252 may indicate that the perceived deficit in performance by data processing system 200 may not be related to the environmental conditions and, therefore, data processing system 201 may be deteriorating.

In an embodiment, data processing system manager 202 is implemented using a processor adapted to execute computing code stored on a persistent storage that when executed by the processor performs the functionality of data processing system manager 202 discussed throughout this application. The processor may be a hardware processor including circuitry such as, for example, a central processing unit, a processing core, or a microcontroller. The processor may be other types of hardware devices for processing information without departing from embodiments disclosed herein.

As discussed above, the components of FIG. 1 may perform various methods to monitor performance of data processing systems throughout a distributed environment. FIG. 3 illustrates methods that may be performed by the components of FIG. 1. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of monitoring performance of a data processing system throughout a distributed environment in accordance with an embodiment is shown. The method may be performed, for example, by a data processing system manager, data processing system, and/or any other device.

At operation 300, an occurrence of an event indicating that operation of a data processing system meets criteria for a duration of time is identified.

Identifying the occurrence of the event may include: (i) obtaining operational data for the data processing system during the duration of time, (ii) obtaining the criteria, (iii) comparing the operational data to the criteria, and/or (iv) other actions

Obtaining the operational data may include (i) receiving the operational data in the form of a message over a communication system, (ii) by accessing a database (locally or offsite) where operational data is stored, (iii) by reading the operational data from storage, and/or other methods. The operational data may be obtained according to a schedule indicating regular transmissions of operational data (e.g., once per hour, once per day, etc.), upon request by an entity for the operational data, and/or by following any other previously determined schedule.

Obtaining the criteria may include (i) receiving the criteria in the form of a message over a communication system, (ii) by accessing a database (locally or offsite) where criteria is stored, (iii) by reading the criteria from storage, and/or other methods. The criteria may be obtained according to a schedule indicating regular transmissions of criteria (e.g., once per hour, once per day, etc.), upon request by an entity for the criteria, and/or by following any other previously determined schedule.

The operational data may be compared to the criteria by: (i) parsing the operational data into a list of characteristics, (ii) parsing the criteria into a list of criteria, each criterion of the list of criteria corresponding to a characteristic of the list of the characteristics, (iii) comparing a quantification of each characteristic to a threshold indicated by each corresponding criterion of the list of criteria, and/or other actions.

Identifying the occurrence of the event may also include obtaining a notification from an entity that the criteria has been met and/or any other actions.

At operation 302, it is determined whether the operation matches simulated operation of the data processing system within a threshold. Determining whether the operation matches the simulated operation within the threshold may include: (i) obtaining simulated operational data for the data processing system, (iii) obtaining a difference between the operational data and the simulated operational data, and/or (iv) comparing the difference to a threshold.

Obtaining the simulated operational data may include: (i) obtaining environmental data indicating the environmental conditions, and/or (ii) initiating operation of the digital twin based on the environmental conditions.

Obtaining the environmental data may include querying a meteorological data source to request weather data for the environment.

Querying the meteorological data source may include: (i) transmitting a request (including, for example, timestamps associated with the duration of time) for the environmental data to the meteorological data source (via a message over a communication system, via a notification in an application on a device, etc.), (ii) providing the request to another entity responsible for querying the meteorological data source, (iii) establishing a schedule for regular (e.g., hourly, daily, weekly, etc.) transmissions of environmental data from the meteorological data source, and/or (iv) other methods of requesting the environmental data.

Obtaining the environmental data may also include: (i) generating, based on the environmental data and historical environmental data for environments proximal to the environment, synthetic environmental data indicating likely environmental conditions of the proximal environments during the duration of time, (ii) adding the synthetic environmental data to the environmental data, and/or other actions

Generating the synthetic environmental data may include: (i) obtaining an inference model trained to generate synthetic environmental data, (ii) feeding the environmental data and the historical environmental data into the inference model as input data, (iii) obtaining the synthetic environmental data as output from the inference model, and/or other actions.

The synthetic environmental data may be added to the environmental data by encapsulating the synthetic environmental data in a data structure previously including the environmental data and initiating a process to store the synthetic environmental data in storage.

Initiating the operation of the digital twin may include (i) obtaining the digital twin of the data processing system, (ii) performing a simulation of operation of the data processing system using the digital twin, and/or (iii) obtaining the simulated operational data based on the simulated operation of the data processing system.

The digital twin may be obtained by: (i) reading the digital twin from storage, (ii) obtaining the digital twin from an entity responsible for generating and/or managing digital twins, (iii) by generating the digital twin (e.g., by obtaining a copy of software executed by the data processing system to perform computer-implemented services), and/or (iv) via other methods. Obtaining the digital twin may also include utilizing the environmental data to establish parameters of the digital twin to simulate operation of the data processing system under certain environmental conditions specified by the environmental data.

Performing the simulation of the operation of the data processing system may include: (i) obtaining input data for the digital twin, and/or (ii) performing computations using the digital twin and the input data to simulate operation of the data processing system.

The input data may be obtained by: (i) receiving a transmission from the data processing system including data provided by one or more sensors associated with the data processing system, (ii) reading the input data from storage, (iii) simulating the input data using an inference model (e.g., a neural network, etc.), (iv) receiving the input data from another entity throughout the distributed environment, and/or (v) via other methods.

Performing the computations using the digital twin and the input data may include feeding the input data into the digital twin and obtaining a simulated output, the simulated output being intended to match an output generated by the data processing system. For example, the data processing system may perform anomaly detection services using temperature measurements from an environment. In this example, the input data may include the temperature measurements and the digital twin may perform anomaly detection using the temperature measurements. The simulated output may include an indication of whether any anomalies exist in the temperature measurements.

The computations may also be performed by providing the input data to another entity responsible for hosting and operating the digital twin and receiving the simulated output in response from the entity.

Obtaining the difference may include: (i) obtaining characteristics of the operation from the operational data, (ii) obtaining characteristics of the simulated operation from the simulated operational data, and/or (iii) obtaining the difference based on the characteristics of the operation and the characteristics of the simulated operation.

For example, the characteristics of the operation may include a list of three characteristics including: (i) a rate of computations performed by the data processing system, (ii) a rate of data transmissions sent and/or received by the data processing system, and (iii) accuracy of computations performed by the data processing system. Similarly, the characteristics of the simulated operation may correspond to the three above listed characteristics. Obtaining the difference in this example may include subtracting each value of the characteristics of the operation from each corresponding value of the characteristics of the simulated operation.

Comparing the difference to the threshold may include: (i) obtaining the threshold (e.g., may be a multi-dimensional threshold including a quantification of a difference between the operation and the simulated operation), and/or (ii) comparing each dimension (e.g., characteristic) of the difference to each corresponding dimension of the threshold.

For example, the threshold may indicate that the acceptable difference between the accuracy of computations in the operation and the accuracy of computations in the simulated operation is 5%. Any difference in percent accuracies larger than 5% may indicate that the difference exceeds the threshold. The threshold may include different types of thresholds and comparing the difference to the threshold may include other operations without departing from embodiment disclosed herein.

If the operation matches the simulated operation within the threshold, the method may proceed to operation 304. If the operation does not match the simulated operation within the threshold, the method may proceed to operation 306.

At operation 304, operation of the data processing system is continued without attempting to remediate an apparent performance deficit in the operation indicated by the criteria.

Continuing to operate the data processing system may include: (i) deducing that the environmental conditions are responsible for the operation meeting the criteria, (ii) performing no action in response to the deducing, (iii) continuing to monitor (and/or monitoring at various intervals for a pre-determined duration of time) operation of the data processing system to determine whether the operation returns to nominal status following alleviation of the environmental conditions, and/or other actions.

Deducing that the environmental conditions are responsible for the operation meeting the criteria may include: (i) removing the data processing system from the list of potentially deteriorating data processing systems, (ii) labeling the data processing system as not deteriorating in a data structure, (iii) transmitting a notification to another entity throughout the distributed environment indicating that the data processing system is not deteriorating, and/or other actions.

The method may end following operation 304.

Returning to operation 302, the method may proceed to operation 306 if the operation does not match the simulated operation within the threshold.

At operation 306, an action set is performed to attempt to remediate the performance deficit in the operation.

Performing the action set may include deducing that the environmental conditions are not responsible for the operation meeting the criteria that the deterioration of the data processing system is responsible for the operation meeting the criteria.

Deducing that the environmental conditions are not responsible for the operation meeting the criteria and that deterioration of the data processing system is responsible for the operation meeting the criteria may include: (i) adding the data processing system to a list of potentially deteriorating data processing systems, labeling the data processing system as potentially deteriorating in a data structure and storing the data structure in storage, transmitting a notification to one or more entities throughout the distributed environment that the data processing system is potentially deteriorating, and/or other actions.

Performing the action set may also include: (i) transmitting a request for diagnostic testing to be performed for the data processing system by an entity, (ii) deploying a replacement data processing system to replace the data processing system, (iii) requesting additional operational data from the data processing system over time to monitor the deterioration of the data processing system, and/or other actions.

The method may end following operation 306.

Any of the components illustrated in FIGS. 1-3 may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows R operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method of managing functionality of data processing systems throughout a distributed environment by a data processing system manager, the method comprising:
identifying an occurrence of a first event indicating that first operation of a first data processing system of the data processing systems meets criteria for a first duration of time;
making a first determination, based on the occurrence of the first event, regarding whether the first operation matches first simulated operation of the first data processing system within a threshold, the first simulated operation being obtained using a digital twin of the first data processing system and being intended to duplicate operation of the first data processing system under first environmental conditions representative of a first environment in which the first data processing system was positioned during the first duration of time;
in an instance of the first determination in which the first operation matches the first simulated operation within the threshold:
continuing to operate the first data processing system without attempting to remediate an apparent performance deficit in the first operation indicated by the criteria.

2. The method of claim 1, wherein identifying the occurrence of the first event comprises:
obtaining operational data for the first data processing system during the first duration of time, the operational data representing the first operation; and
comparing the operational data to the criteria.

3. The method of claim 2, wherein making the first determination comprises:
obtaining simulated operational data for the first data processing system, the simulated operational data being based on:
simulated nominal operation of the first data processing system using the digital twin, and
the first environmental conditions;
obtaining a difference based on the operational data and the simulated operational data; and
comparing the difference to the threshold.

4. The method of claim 3, wherein obtaining the simulated operational data comprises:
obtaining environmental data indicating the first environmental conditions; and
initiating operation of the digital twin based on the first environmental conditions.

5. The method of claim 4, wherein obtaining the environmental data comprises:
querying a meteorological data source to request weather data for the first environment.

6. The method of claim 5, wherein obtaining the environmental data further comprises:
generating, based on the environmental data and historical environmental data for environments proximal to the first environment, synthetic environmental data indicating likely environmental conditions of the proximal environments during the first duration of time; and
adding the synthetic environmental data to the environmental data.

7. The method of claim 1, wherein continuing to operate the first data processing system comprises:
deducing that the first environmental conditions are responsible for the first operation meeting the criteria.

8. The method of claim 1, further comprising:
identifying an occurrence of a second event indicating that second operation of a second data processing system of the data processing systems meets the criteria for a second duration of time;
making a second determination, based on the occurrence of the second event, regarding whether the second operation matches second simulated operation of the second data processing system within the threshold, the second simulated operation being obtained using a digital twin of the second data processing system and being intended to duplicate operation of the second data processing system under second environmental conditions representative of a second environment in which the second data processing system was positioned during the second duration of time;
in an instance of the second determination in which the second operation does not match the second simulated operation within the threshold:
performing an action set to attempt to remediate a performance deficit in the second operation.

9. The method of claim 8, wherein performing the action set comprises:
deducing that the second environmental conditions are not responsible for the second operation meeting the criteria and that deterioration of the second data processing system is responsible for the second operation meeting the criteria.

10. The method of claim 9, wherein the second operation is substantially similar to the first operation and the first environmental conditions are different from the second environmental conditions.

11. The method of claim 8, wherein the first event is a first reduction in computation speed by the first data processing system and the second event is a second reduction in computation speed by the second data processing system, the first reduction being substantially similar to the second reduction.

12. The method of claim 1, wherein the first operational data comprises at least one characteristic selected from a list of characteristics consisting of:
a rate of computations performed by the first data processing system;
a range of data transmissions by the first data processing system; and
a quantification of accuracy of operations performed by the first data processing system.

13. The method of claim 12, wherein the threshold is a multi-dimensional threshold comprising a list of thresholds, each threshold of the list of the thresholds corresponding to a characteristic of the list of the characteristics.

14. A non-transitory machine-readable medium having instructions stored therein, which when executed by a processor, cause the processor to perform operations for managing functionality of data processing systems throughout a distributed environment by a data processing system manager, the operations comprising:
identifying an occurrence of a first event indicating that first operation of a first data processing system of the data processing systems meets criteria for a first duration of time;
making a first determination, based on the occurrence of the first event, regarding whether the first operation matches first simulated operation of the first data processing system within a threshold, the first simulated operation being obtained using a digital twin of the first data processing system and being intended to duplicate operation of the first data processing system under first environmental conditions representative of a first environment in which the first data processing system was positioned during the first duration of time;
in an instance of the first determination in which the first operation matches the first simulated operation within the threshold:
continuing to operate the first data processing system without attempting to remediate an apparent performance deficit in the first operation indicated by the criteria.

15. The non-transitory machine-readable medium of claim 14, wherein identifying the occurrence of the first event comprises:
obtaining operational data for the first data processing system during the first duration of time, the operational data representing the first operation; and
comparing the operational data to the criteria.

16. The non-transitory machine-readable medium of claim 15, wherein making the first determination comprises:
obtaining simulated operational data for the first data processing system, the simulated operational data being based on:
simulated nominal operation of the first data processing system using the digital twin, and
the first environmental conditions;
obtaining a difference based on the operational data and the simulated operational data; and
comparing the difference to the threshold.

17. The non-transitory machine-readable medium of claim 16, wherein obtaining the simulated operational data comprises:
obtaining environmental data indicating the first environmental conditions; and
initiating operation of the digital twin based on the first environmental conditions.

18. A data processing system, comprising:
a processor; and
a memory coupled to the processor to store instructions, which when executed by the processor, cause the processor to perform operations for managing functionality of data processing systems throughout a distributed environment by a data processing system manager, the operations comprising:
identifying an occurrence of a first event indicating that first operation of a first data processing system of the data processing systems meets criteria for a first duration of time;
making a first determination, based on the occurrence of the first event, regarding whether the first operation matches first simulated operation of the first data processing system within a threshold, the first simulated operation being obtained using a digital twin of the first data processing system and being intended to duplicate operation of the first data processing system under first environmental conditions representative of a first environment in which the first data processing system was positioned during the first duration of time;
in an instance of the first determination in which the first operation matches the first simulated operation within the threshold:
continuing to operate the first data processing system without attempting to remediate an apparent performance deficit in the first operation indicated by the criteria.

19. The data processing system of claim 18, wherein identifying the occurrence of the first event comprises:
obtaining operational data for the first data processing system during the first duration of time, the operational data representing the first operation; and
comparing the operational data to the criteria.

20. The data processing system of claim 19, wherein making the first determination comprises:
obtaining simulated operational data for the first data processing system, the simulated operational data being based on:
simulated nominal operation of the first data processing system using the digital twin, and
the first environmental conditions;
obtaining a difference based on the operational data and the simulated operational data; and
comparing the difference to the threshold.
